(19) United States
(12) Patent Application Publication
(10) Pub. No.: US 2025/0147776 A1
(43) Pub. Date: May 8, 2025

(54) PROVIDING RESPONSES AMONG A PLURALITY OF USER INTERFACES BASED ON STRUCTURE OF USER INPUT

(71) Applicant: Wells Fargo Bank, N.A., San Francisco, CA (US)

(72) Inventors: Ashish B. Kurani, Hillsborough, CA (US); Alan W. Hecht, Chanhassen, MN (US); Muhammad Farukh Munir, Pittsburg, CA (US); Darius A. Miranda, San Francisco, CA (US); Benjamin Taylor, Willston, VT (US); Traci Nguyen, San Francisco, CA (US); Kourtney Eidam, Marietta, GA (US); Wairnola Marria Rhodriquez, San Francisco, CA (US)

(73) Assignee: Wells Fargo Bank, N.A., San Francisco, CA (US)

(21) Appl. No.: 18/387,984

(22) Filed: Nov. 8, 2023

(51) Int. Cl. G06F 9/451

(52) U.S. Cl. CPC G06F 9/451

(57) ABSTRACT

A system includes at least one processing circuit including at least one memory storing instructions therein that are executable by one or more processors to: obtain, via a first user interface, a query associated with a profile of a user, the first user interface configured to present an output corresponding to a first format; generate, based on the query and first data corresponding to the profile of the user, second data as a response to the query; select, according to a determination that a structure of the second data satisfies a heuristic corresponding to a second format, a second user interface configured to present an output corresponding to the selected second format; and cause the second user interface to present an output in the selected second format corresponding to at least a portion of the second data.

### TECHNICAL FIELD

The present implementations relate generally to user interfaces and, more particularly, to providing responses among and via a plurality of user interfaces based on a structure of a user input.

### BACKGROUND

Users increasingly demand faster communication and information delivery across a wider range of platforms. However, conventional systems ineffectively or inefficiently identify appropriate platforms for communicating with particular users due, at least, to a lack of awareness of communication and/or information environments for the particular users. Thus, users can be funneled into interactions that provide limited or ineffective communication of information in an environment not suited for that communication thereby raising security risks for transmitting certain types of information via one or more platforms. Improving communication systems and methods is thus desirable. Improved communication systems become even more important when the content of the information is considered. For example, users may desire that sensitive information, such as financial information or personally identifiable information, be maintained in a relatively more secure manner than non-sensitive information.

### SUMMARY

The systems, methods, and computer-readable media of the technical solution relate to providing user interface (UI) presentations with certain information via one or more user interfaces based on one or more aspects of information, such as a content of the information, an input device of a query associated with the information, and so on. According to an example implementation according to this disclosure, connected devices can obtain wealth management questions, and then provide answers via one or more platforms. An example includes a user providing a question to a smart speaker (e.g., “how much do I need to save on a monthly basis to obtain my savings goal of $Y?”). In response, an avatar in a meta-verse provides an answer to pertinent questions, as many users do not know what to ask or how to ask it.

For example, systems, methods, and computer-readable media of the technical solution can identify or be associated with a plurality of user interfaces, each having distinct input and/or output devices. The plurality of user interfaces can be configured to receive one or more inputs according to one or more predetermined formats, types of formats, ranges of formats, or any combination thereof. For example, a user interface can receive a query via a first input device according to a first format and can cause a system to generate a response to the query. This technical solution can provide the response to a user interface configured to present the response. For example, this technical solution can provide the response to a mobile device, a virtual environment, a speech assistant device, or any combination thereof, according to the structure of the response. For example, the structure of the response can correspond to one or more formats of data of the response. For example, the system can provide a response to a query by a second user interface distinct from the user interface receiving input corresponding to the query. Thus, a technical solution for providing responses among a plurality of user interfaces based on a structure of user input is provided. This technical solution can provide a technical improvement of at least allocating responses to user interfaces based on quantitative attributes corresponding to one or more of the user interfaces, the response, and a profile of a user providing the query on which the response is based.

At least one aspect is directed to a system. The system can include at least one processing circuit including at least one memory storing instructions therein that are executable by one or more processors to: obtain, via a first user interface, a query associated with a profile of a user, the first user interface configured to present an output corresponding to a first format; generate, based on the query and first data corresponding to the profile of the user, second data as a response to the query; select, according to a determination that a structure of the second data satisfies a heuristic corresponding to a second format, a second user interface configured to present an output corresponding to the selected second format; and cause the second user interface to present an output in the selected second format corresponding to at least a portion of the second data.

At least one aspect is directed to a method. The method includes: obtaining, via a first user interface, a query associated with a profile of a user, the first user interface configured to present output corresponding to a first format; generating, based on the query and first data corresponding to the profile of the user, second data as a response to the query; selecting, according to a determination that a structure of the second data satisfies a heuristic corresponding to a second format, a second user interface configured to present output corresponding to the selected second format; and causing the second user interface to present an output in the selected second format corresponding to at least a portion of the second data.

At least one additional aspect is directed to a non-transitory computer readable medium storing instruction that, when executed by one or more processors, cause the one or more processors to perform operations. The operations including: obtaining, via a first user interface, a query associated with a profile of a user, the first user interface configured to present output corresponding to a first format; generating, based on the query and first data corresponding to the profile of the user, second data as a response to the query; selecting, according to a determination that a structure of the second data satisfies a heuristic corresponding to a second format, a second user interface configured to present output corresponding to the selected second format; and causing the second user interface to present an output in the selected second format corresponding to at least a portion of the second data.

This summary is illustrative only and is not intended to be in any way limiting. Other aspects, inventive features, and advantages of the devices or processes described herein will become apparent in the detailed description set forth herein, taken in conjunction with the accompanying figures, wherein like reference numerals refer to like elements. Numerous specific details are provided to impart a thorough understanding of embodiments of the subject matter of the present disclosure. The described features of the subject matter of the present disclosure may be combined in any suitable manner in one or more embodiments and/or implementations. In this regard, one or more features of an aspect of the invention may be combined with one or more features of a different aspect of the invention. Moreover, additional features may be recognized in certain embodiments and/or implementations that may not be present in all embodiments or implementations.

### BRIEF DESCRIPTION OF THE FIGURES

These and other aspects and features of the present implementations are depicted by way of example in the figures discussed herein. Present implementations can be directed to, but are not limited to, examples depicted in the figures discussed herein. Thus, this disclosure is not limited to any figure or portion thereof depicted or referenced herein, or any aspect described herein with respect to any figures depicted or referenced herein.

FIG. 1 depicts an example computing system, according to an example embodiment.

FIG. 2 depicts an example system circuit computing system architecture, according to an example embodiment.

FIG. 3A depicts an example input state of a first multimodal user interface environment, according to an example embodiment.

FIG. 3B depicts an example handoff state of a first multimodal user interface environment, according to an example embodiment.

FIG. 4 depicts an example output state of a first multimodal user interface environment, according to an example embodiment.

FIG. 5A depicts an example input state of a second multimodal user interface environment, according to an example embodiment.

FIG. 5B depicts an example handoff state of a second multimodal user interface environment, according to an example embodiment.

FIG. 6 depicts an example output state of a second multimodal user interface environment, according to an example embodiment.

FIG. 7 depicts an example method of providing responses among a plurality of user interfaces based on a structure of user input, according to an example embodiment.

FIG. 8 depicts an example method of providing responses among a plurality of user interfaces based on a structure of user input, according to an example embodiment.

### DETAILED DESCRIPTION

Aspects of this technical solution are described herein with reference to the figures, which are illustrative examples of this technical solution. The figures and examples below are not meant to limit the scope of this technical solution to the present implementations or to a single implementation, and other implementations according to an example embodiment are possible, for example, by way of interchange of some or all of the described or illustrated elements.

The systems, methods, and computer-readable media described herein provide, according to various embodiments, a computing framework structured to receive user queries via multiple types of interactive computing environments/devices, and to guide users to an appropriate interactive computing environment to consume content responsive to the user queries. For example, a user can provide input by a mobile device, and can be guided to a virtual environment in which an avatar in the virtual environment provides a response to the user query. The systems, methods, and computer-readable media of the technical solution relate to providing one or more outputs to a user interface having an aspect or configuration best suited to provide the one or more outputs according to one or more attributes associated with the user interface and the one or more outputs and/or queries. For example, a system can receive an input or query via a first user interface having a first format and can generate a response to the query including data having a particular structure that is provided as an output via a second client system or device (e.g., a laptop user interface to a mobile device user interface). For example, a structure of the data can correspond to a type or content of the data. A type of structure of data, for example, input or output includes at least one of text, voice, sound, or any combination thereof. Content of the input/query or output may include, but is not limited to, at least one of financial information, personal information, or any combination thereof. Content can have a structure type associated therewith, such as an image, video, audio, or any combination thereof. The system can identify a user interface having one or more attributes that satisfy a heuristic corresponding to the structure of the data. For example, the data can have a structure corresponding to a data type that defines the data as being useable in a virtual environment (e.g., executable by a virtual environment, including one or more references to one or more elements of a virtual environment etc.). Based on this data structure, the system can select a user interface corresponding to a virtual environment because the virtual environment is configured to at least partially present the structure of the data of the response. In some embodiments, the computing system can identify at least one user interface according to a particular profile of a particular user. For example, the computing system can identify that a profile of a user is associated with a plurality of predetermined devices each having corresponding user interfaces (e.g., input/output devices of a user client device that provides an interface for communicating with a user, such as a touchscreen of a user mobile device), and can select or identify a user interface of the plurality predetermined devices corresponding to the structure of the data from among the plurality of user interfaces of the plurality of predetermined devices associated with the profile of the user.

In operation, the computing system may utilize one or more heuristics and associated heuristic thresholds. As used herein, a “heuristic” refers to the use of one or more criterion or conditions to control selection of a user device (and associated user interface). Thus, as discussed herein, the heuristic can include on one or more instructions to detect a condition, execute a comparison, determine a value of an input, determine a property of an object, or any combination thereof to in turn control the selection of a user device (and associated user interface) regarding a communication with a user with a first user device followed by another communication with the user with one or more additional user devices.

An example of the present disclosure is as follows. A user may be a customer of a provider institution (e.g., of various products and/or services, such as a financial institution). The user may utilize a mobile client application associated with or provided by, at least partly, the provider institution (e.g., a mobile banking client application). The provider institution computing system may have a system memory storing one or more profile metrics. The profile metrics may contain information regarding the customers/users of the provider institution. The user account of the user may have predefined devices with user interfaces associated with the user account, such as a mobile application, a virtual environment (e.g., a virtual reality set such as AR/VR headset), etc. The heuristics described herein may be used, by the provider computing system, to define when to select and control one or more user devices associated with the user account. Thus, and as a particular example, the user can provide a touch input to the mobile client application via a mobile device, with text such as “how has my portfolio performed this year?” The user may alternatively provide voice input to a voice assistant of the mobile client application via the mobile device or a dedicated voice assistant device (e.g., a smart speaker), with similar query content to “how has my portfolio performed this year?” The provider computing system can receive the query, and generate a response based on the query/input. For example, the response may be structured to include one or more charts, graphs, tables, summaries, and/or media content (e.g., video clips). The provider computing system can provide a message to the user including some of the information of the response (e.g., an overall growth of the portfolio since the beginning of the year), and can provide a link in a notification for the user to access information regarding the response in another environment different from the platform that received the query, such as a virtual environment which may be provided via an AR/VR headset. The user can follow the link to the virtual environment from another device, including a tablet or laptop. The user can then view one or more graphical user interfaces in the virtual environment that depict a presentation of the content of the response (e.g., sequentially presenting charts and graphs visually, providing speech output including the summaries, etc.).

Technically and beneficially, the systems, methods, and computer-readable media described herein provide at a technical improvement of selecting user interfaces, computing devices, and/or any combination thereof, according to their suitability to present content of a given response to a given query. For example, the technical improvement can result in a computing environment with improved communication interfaces capable of transmitting and routing responses to queries having more complex data structures that can include a plurality of objects with a plurality of data types. For example, a provider computing system as discussed herein can present more data-rich and interactive responses to user queries, and can select among multiple devices and platforms associated with a user to not only improve the efficacy of such communications but to improve security associated with such communications. For example, the provider computing system can receive a query of “Show me performance of my portfolio from the past year and into next year.” The provider computing system can obtain a response including multiple bar, line and doughnut charts showing past and projected future performance of a portfolio, and text describing the charts specific to the user. The provider computing system can identify that an account of the user is associated with a mobile device, a tablet device, a laptop device. The provider computing system can select the tablet device to display the charts and provide the text summaries visually because the tablet device satisfies the predefined heuristic of visually depicting the most amount of content. The provider computing system can route the content of the response to the tablet device to provide a technical improvement to increase communication security by transmitting content of a response to a platform with higher security.

An example of a security protocol providing higher security for cross-device communication and various advantages associated therewith is described below. A user provides a text input to a client application operated by a financial institution of “portfolio growth by account.” The user submits the query to the provider computing system operated by the financial institution. The provider computing system can determine that transmission of a response that describes account information and balances is restricted from a mobile device due to a predetermined identification of the mobile device as not authorized to present account information in a response. Here, the provider computing system transmits a push notification to the client application of the user device with a link to secure remote system including a virtual environment accessible by the user's tablet device that does not leave the user's home based on GPS history associated with the user device. The GPS history of the user device can be provided as input to the provider computing system to allow the provider computing system to generate a profile metric associated with the user's tablet that identifies the user's tablet as located at the home or having a low risk of being located in a low-security environment (e.g., outside a geofence that defines a home area).

Beneficially as described herein, the transition and continuation of interactions between and among platforms (e.g., a dialogue started on one platform, such as in the real world, continues on another platform such as a virtual world), and authentication of the user to maintain privacy of sensitive information results in improved communication security (e.g., of sensitive information). Implementation of different security protocols regarding what types of information may be exchanged through different platforms, such that the provider computing system determines that providing an answer may require providing information that may violate a security protocol and thus limits how much information is provided through one platform (absent an override), and recommends continuing the exchange of information through another platform.

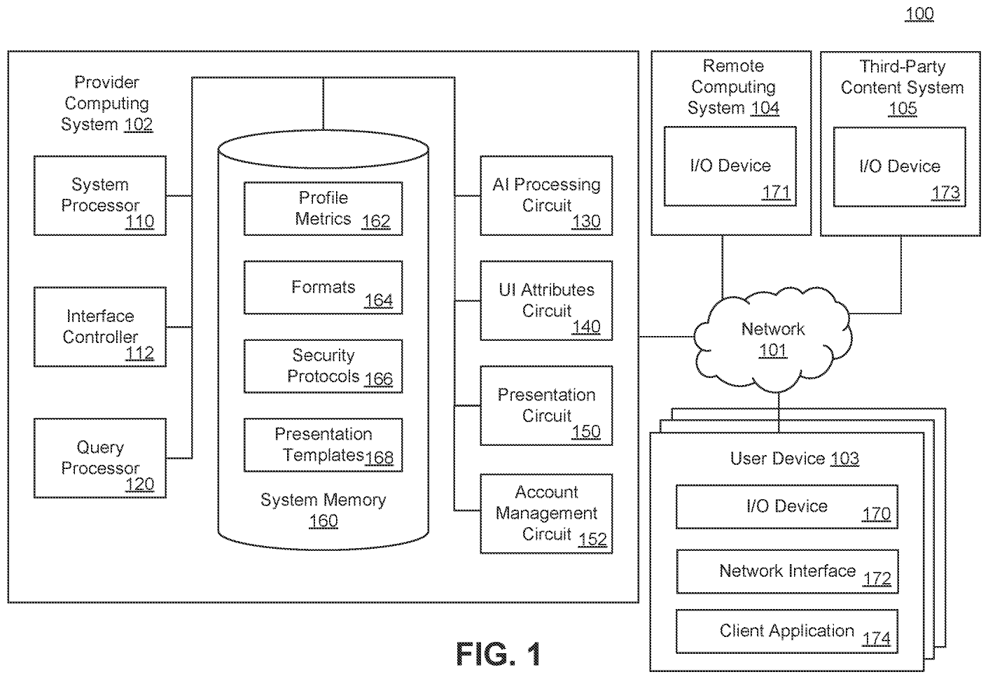

Based on the foregoing, referring now to FIG. 1, a computing system 100 is shown, according to an example embodiment. As described herein, the systems and components of the computing system 100 are structured to enable the transition and continuation of interactions between and among platforms (e.g., a dialogue started on one platform, such as in the real world, continues on another platform such as a virtual world) along with various predefined authentication requirements of the user to maintain privacy of information, such as sensitive information. The computing system 100 is shown to include at least a network 101, a provider computing system 102 associated with a provider institution, a user device 103 associated with one or more users, and a remote computing system 104, and a third-party content system 105.

A user may connect a plurality of devices to the financial system computing system via a mobile application. The mobile application may enable the user to add devices, such as smart speakers, smart TVs, etc. The mobile application may also be connected or provided in a virtual reality world, such as a meta-verse. There may be security protocols implemented that control adding the devices to the account linked to the mobile application. Further, the mobile application may link, via one or more credentials, to third-party accounts. The mobile application may provide information to the user, such as balance information from third-party accounts. The mobile application may provide/depict wealth information that may otherwise be difficult to identify. For example, the mobile application may be connected to a real estate application or server to provide a current home valuation of the user and this information may be inputted into a graphical depiction of their “wealth.” As such, a more thorough wealth picture of the user may be provided. After the devices are connected, the user may simply go about their day-to-day routine and ask financial questions (e.g., vocally that is captured by the speaker, non-vocally that is captured by a VR device or a camera, a combination thereof, textually that is captured by the mobile application, etc.). These questions are fed into the mobile application and/or the provider system. If the question is jumbled or difficult to comprehend, the provider system may analyze the question from a repository of stored questions to identify a “more likely than not” question of the user.

The network 101 can include any type or form of network. The geographical scope of the network 101 can vary widely and the network 101 can include a body area network (BAN), a personal area network (PAN), a local-area network (LAN), e.g., Intranet, a metropolitan area network (MAN), a wide area network (WAN), or the Internet. The topology of the network 101 can be of any form and can include, e.g., any of the following: point-to-point, bus, star, ring, mesh, or tree. The network 101 can include an overlay network which is virtual and sits on top of one or more layers of other networks 101. The network 101 can be of any such network topology capable of supporting the operations described herein. The network 101 can utilize different techniques and layers or stacks of protocols, including, e.g., the Ethernet protocol, the Internet protocol suite (TCP/IP), the ATM (Asynchronous Transfer Mode) technique, the SONET (Synchronous Optical Networking) protocol, or the SD (Synchronous Digital Hierarchy) protocol. The TCP/IP Internet protocol suite can include application layer, transport layer, Internet layer (including, e.g., IPv6), or the link layer. The network 101 can include a type of a broadcast network, a telecommunications network, a data communication network, or a computer network. The provider computing system 102, the user device 103, and/or the remote computing system 104 are in communication with each other and are connected by a network 101.

The provider computing system 102, also referred to herein as a provider institution computing system, is owned by, associated with, or otherwise operated by a provider institution (e.g., a bank or other financial institution) that maintains one or more accounts held by various customers (e.g., the customer associated with the user device 103), such as demand deposit accounts, credit card accounts, reserve (e.g., holding) accounts that are described in more detail below, receivables accounts, and so on. In some instances, the provider computing system 102, for example, may include one or more servers, each with one or more processing circuits having one or more processors configured to execute instructions stored in one or more memory devices to send and receive data stored in the one or more memory devices and perform other operations to implement the methods described herein associated with logic or processes shown in the figures. In some instances, the provider computing system 102 may be or may include various other devices communicably coupled thereto, such as, for example, desktop or laptop computers (e.g., tablet computers), smartphones, wearable devices (e.g., smartwatches), and/or other suitable devices. In the example shown, the provider computing system 102 can include a physical computer system operatively coupled or couplable with one or more components of the computing system 100, either directly or directly through an intermediate computing device or system. The provider computing system 102 can include a virtual computing system, an operating system, and a communication bus to effect communication and processing.

In the example shown, the provider computing system 102 includes a system processor 110, an interface controller 112, a query processor 120, an AI processing circuit 130, a UI attributes circuit 140, a presentation circuit 150, an account management circuit 152, and a system memory 160. The provider computing system 102 can include one or more logical or electronic devices including, but not limited to, integrated circuits, logic gates, flip flops, gate arrays, programmable gate arrays, and the like. One or more electrical, electronic, or like devices, or components associated with the provider computing system 102 can also be associated with, integrated with, integrable with, replaced by, supplemented by, complemented by, or the like, the system processor 110 or any component thereof.

The system processor 110 can be one or more processors that are structured or configured to execute one or more instructions associated with the computing system 100. The system processor 110 can include one or more electronic processors, integrated circuits, and/or the like, including one or more of digital logic, analog logic, and the like. The system processor 110 can include, but is not limited to, at least one microcontroller unit (MCU), microprocessor unit (MPU), central processing unit (CPU), graphics processing unit (GPU), physics processing unit (PPU), embedded controller (EC), or the like. The system processor 110 can include a memory operable to store or storing one or more instructions for operating components of the system 102 and operating components operably coupled to the system processor 110. For example, the one or more instructions can include one or more of firmware, software, operating systems, embedded operating systems, etc. The system processor 110 or the computing system 100 can include one or more communication bus controllers to effect communication between the system processor 110 and the other elements of the computing system 100.

The interface controller 112 can link the provider computing system 102 with one or more of the network 101, the user device 103, and the remote computing system 104. The interface controller 112 may be an integrated circuit (IC) having one or more circuits each having an architecture, such as a gate architecture, to implement a network communication interface to convert network communication into one or more characters. The interface controller 112 is capable of unidirectional, bidirectional, half-duplex, or full-duplex communication according to the network communication interface. A communication interface can include, for example, an application programming interface (“API”) compatible with a particular component of the provider computing system 102, the user device 103, and/or the remote computing system 104. The communication interface can provide a particular communication protocol compatible with a particular component of the provider computing system 102 and a particular component of the user device 103 or the remote computing system 104. The interface controller 112 can be compatible with particular content objects, and can be compatible with particular content delivery systems corresponding to particular content objects, structures of data, types of data, or any combination thereof. For example, the interface controller 112 can be compatible with transmission of video content, audio content, or any combination thereof. For example, the interface controller 112 can be compatible with a virtual environment via a protocol compatible with latency and encryption corresponding to a virtual environment.

As described herein, a provider computing system or data processing system is structured to determine whether the content of a response to an input or query is compatible with one or more of various user devices (e.g., user interfaces of the user devices) according to the heuristic discussed herein (i.e., satisfies one or more heuristics). For example, the provider computing system can determine that the content of the response is compatible with a particular user interface of a particular user device. The determination that the content of the response is compatible is compatible with the particular user interface (e.g., mobile device user interface) is an example of a determination that satisfies the heuristic. For example, the provider computing system can determine that the content of the response is not compatible with the user interface as discussed above, by a search that determines that a row including the type of content and the type of user interface is absent from the table. The determination that the content of the response is not compatible with the user interface is an example of a determination that does not satisfy the heuristic. The determination that the content of the response is not compatible with the user interface is an example of a determination that does not satisfy the heuristic can be a determination that the content of the response satisfies a third format distinct from the first format. Thus, the provider computing system can make multiple determinations according to one or more heuristics.

The query processor 120 can analyze, parse, inspect, or otherwise process an input/prompt/query received from the user device 103 (and/or other computing systems). For example, the query processor 120 may be an integrated circuit (IC) having one or more circuits each having a particular architecture, such as a gate architecture, to implement a text processor. The query processor 120 is configured or structured to receive one or more text strings from the network communication interface of the interface controller 112. The query processor 120 may be configured to receive a text input, voice input, image input, video input, and/or any combination thereof (e.g., query) from the user device 103. The query processor 120 may be configured to tokenize the text input into tokens (e.g., phrases, passages, individual words, sub-words, punctuation, etc.). The query processor 120 may be configured to transform, convert, or otherwise encode each token generated for the text input into an encoded token. The encoded token may be encoded into a format (such as vector format, word embeddings, etc.) that is compatible with the presentation circuit 150 or one or more user interfaces corresponding to the presentation circuit 150, as described in greater detail herein. The query processor 120 may tokenize the query and encode the tokens for applying to, for example, a neural network of the AI processing circuit 130. The query processor 120 can detect a particular structure or format of the input or the query and can generate a query having a particular structure or format, based on the input.

The AI processing circuit 130 is structured or configured to provide one or more data transformations according to one or more models, where the data transformations are semantically meaningful. For example, the AI processing circuit 130 may be one or more processors, such as an integrated circuit (IC) having one or more circuits each having a gate architecture to train, update, or execute an AI model. The AI processing circuit 130 is structured or configured to receive one or more queries from the query processor 120. For example, the AI processing circuit 130 may be or include a neural network (such as a generative pre-trained transformer neural network) trained to generate responses to queries. In some embodiments, the neural network may be trained using data from, at least, the system memory 160. In this the regard, the neural network(s) may be trained using the standardized, labeled data ingested or otherwise received from the external source(s) and internal source(s). In some embodiments, the neural network(s) may be trained using the dataset stored in the consolidated database(s) 114, along with various examples of answers to queries. The neural network(s) may be trained by tokenizing the dataset, initializing the weights and biases of the neural network(s), feeding inputs (e.g., example queries) to the neural network(s), and using a loss function to quantify discrepancies between the response to the queries generated by the neural network(s) and the answer. The neural network(s) may update the weights/biases based on the output/discrepancy until the neural network(s) satisfies various testing/training criteria. At the deployment stage, the neural network(s) may be configured to receive the encoded tokenized query as an input (e.g., to an input layer of the neural network(s)), perform forward propagation of the encoded tokens to the neural network, extract features, perform non-linear transformations, perform contextual understanding, and generate an output.

In some embodiments, the AI processing circuit 130, upon determining a context of the query, may generate one or more additional or subsequent queries to obtain data relevant to the initial query. The AI processing circuit 130 may be configured to retrieve or otherwise request data which is relevant to the information which was requested. For example, if the query asks for financial information relating to a particular company (e.g., Acme Co.), the AI processing circuit 130, upon determining that the context of the query is financial information relating to Acme Co., may generate a query to database 114 and/or one or more data source(s) to obtain information/data identifying Acme Co. or including the name Acme Co. For example, the AI processing circuit looks up stored information in a database and/or performs an Internet search to accumulate information from one or more websites. The AI processing circuit 130 may be configured to supply the data as an input to the AI processing circuit 130 for generating various projections/outlook information relating to the query. In this regard, the AI processing circuit 130 may be configured to query for real-time or near real-time data as an input, to provide more accurate projections/reports/responses.

The UI attributes circuit 140 is structured or configured to generate and modify one or more attributes of one or more queries, inputs, responses, outputs, user interfaces, devices, or any combination thereof. As described herein, an “attribute” of one or more queries, inputs, responses, outputs, user interfaces, and devices refers to a data structure that control presentation of a visual or an audio element of a user interface. An attribute is, for example, an identifier of a type of user interface or content. For example, an attribute is a string “TEXT” that identifies a type of content as text. As another example, an attribute is a string “CHART” that identifies a type of content as a chart. As still another example, an attribute is a string “VIDEO” that identifies a type of content as video. As still another example, an attribute is a string “AUDIO” that identifies a type of content as audio. As still another example, an attribute is a string “MOBILE” that identifies a type of user interface as associated with a mobile device. As still another example, an attribute is a string “TABLET” that identifies a type of user interface as associated with a tablet device. As still another example, an attribute is a string “ARVR” that identifies a type of user interface as associated with an AR/VR application running on an AR/VR.

The UI attributes circuit 140 is structured or configured to generate an attribute(s) that indicates or specifies one or more structures or formats corresponding to one or more queries, responses, user interfaces, or any combination thereof. For example, the UI attributes circuit 140 can generate an attribute to indicate that a particular structure of data corresponds to a virtual environment. For example, the UI attributes circuit 140 can generate an attribute to indicate that a particular structure of data corresponds to a particular volume or size of text data, voice data, image data, video data, or any combination thereof. The UI attributes circuit 140 can generate attributes corresponding to one or more heuristics. For example, the attribute circuit can detect one or more communication channels, computing resources, processor configurations, operating system configurations, or any combination thereof, to associate a particular user interface or a particular device with a particular heuristic. For example, the UI attributes circuit 140 can associate a user interface corresponding to a virtual environment according to a detection of a communication interface, communication protocol, processor architecture, operating system, or any combination thereof, corresponding to a virtual environment. For example, a computing system can identify that a query from a user was received by a communication interface associated with a virtual environment. The computing system can then provide a message to the user to remain in the virtual environment, upon determining that response includes objects that are suitable for presentation in the virtual environment. For example, a user can type a query into search box of a mobile client application 174 of “show growth of my savings account with monthly contributions of $200.” The user can receive a message at the mobile device 103 to visit the user's room with the financial institution in an ARVR environment to receive the response. The user can receive a preview of the response of “Growth is 25% over 5 years. Visit your Virtual Room to find out more.” The user can visit the virtual room to receive presentation by a virtual banker avatar to explain the growth of the account with charts included in the response to the user's query. For example, a client application 174 is a web application run via a browser executing on the user device 103. For example, a client application 174 is a mobile application run via an operating system executing on the user device 103.

For example, a heuristic may be a logic operation to determine whether content of a response to a query is associated with a given type of a user interface. For example, the heuristic may include a table indicating which user interfaces can display which types of data. In operation, then, the table may define user interfaces that can or cannot display a given piece of content of a response (e.g., based on whether the table includes a row with the type of content of the response and the type of user interface associated with the user). For example, the table may have a row listing a user device type as a desktop device and a data type as chart content, and the table indicates that the desktop device can display chart content. As another example, the table may have a row listing a user device type as a mobile device and a data type as message content, and the table indicates that the mobile device can display message content. As still another example, the table may have a row including a gaming device as the user device type and AR/VR content as the data type, and the table indicates that the gaming device can display AR/VR content. In this way, the gaming device may include specific hardware and machine-readable media that enables the reception, processing, and presentment of AR/VR content that other devices may not. Building on this example and as another example, the table may have a row including a desktop device as a user device type and AR/VR content as the data structure type, and the table indicates that the desktop device cannot display AR/VR content because the particular desktop type is not adaptable for processing and presentment of AR/VR content. As yet another example, the table may have a row including a voice assistant device as a user device type and audio content as the data structure type, and the table indicates that the desktop device can also display AR/VR content.

The presentation circuit 150 is structured or configured to generate, determine, or otherwise provide one or more outputs at least partially corresponding to a response by the output from the AI processing circuit 130 (and/or other systems or components). For example, the presentation circuit 150 may be structured or configured to generate or transform a structure of data corresponding to a response to a particular user interface or a particular heuristic. For example, the presentation circuit 150 can select a user interface corresponding to a structure of data corresponding the user interface and can transmit the response having the particular data structure to one or more user interfaces configured to present the response according to the structure. For example, the presentation circuit 150 can be configured to provide responses in various formats, including for example text outputs, table outputs, visual or graphical outputs, and so forth, or to instruct or cause a user interface to provide responses in various formats. The presentation circuit 150 may be configured to generate the responses at one or more of the user devices 103 or the remote computing system 104.

The system memory 160 can store data associated with the computing system 100. The system memory 160 can be or include one or more hardware memory devices to store binary data, digital data, or the like. The system memory 160 can include one or more electrical components, electronic components, programmable electronic components, reprogrammable electronic components, integrated circuits, semiconductor devices, flip-flops, arithmetic units, or the like. The system memory 160 can include at least one of a non-volatile memory device, a solid-state memory device, a flash memory device, or a NAND memory device. The system memory 160 can include one or more addressable memory regions disposed on one or more physical memory arrays. A physical memory array can include a NAND gate array disposed on, for example, at least one of a particular semiconductor device, integrated circuit device, or a printed circuit board device. The system memory 160 can include profile metrics database 162, formats database 164, security protocols database 166, and presentation templates database 168. One of the of the databases 162, 164, 66 and 168 can be portions of the system memory 160. For example, the system memory 160 can include one or more respective regions of a flash or disk memory allocated respectively to each of the databases 162, 164, 166 and 168.

The profile metrics database 162 can store or hold information or data regarding one or more users of the provider institution computing system 102. For example, the profile metrics database 162 can respectively link various user interfaces, devices, or any combination thereof, with a corresponding user in a user profile. The provider computing system 102 and, particularly the system memory 160, may include a profile metrics database 162. In some embodiments, the profile metrics database 162 is a separate database relative to the system memory 160. The profile metrics database 162 is structured or configured to retrievably store user information associated with the one or more users, who may be associated with, own, and/or manage one or more user devices 103. In some instances, the user information may include a name, a phone number, an e-mail address, a physical address, account information (e.g., account number), notification settings, credit accounts, credit limits, etc. of the user. As described herein, the provider computing system 102 may be configured to receive and store the user information into personalized user profiles of the profile metrics database 162.

The account management circuit 152 is structured or configured to perform a variety of functionalities or operations to enable and monitor various customer activities (e.g., managing credit transactions, credit accounts, holding accounts, etc.) in connection with user profile data stored within the profile metrics database 162. For example, the account management circuit 152 can store predefined settings that define or control interactions between the provider computing system 102 and the user devices 103. For example, the account management circuit 152 can select, based on a predefined relationships between types of user interfaces and types of content by various heuristics as discussed above, a user interface to present given content by type. For example, the provider computing system 102 can detect a type of authentication that is required to transition from a mobile device interface to a virtual environment, and vice versa. For example, the virtual environment supports an authentication schema that has an end-to-end encryption layer that is unavailable via the user device 103.

The provider computing system 102 may analyze the user's financial information to provide an answer to that question and visual depictions associated with the question may be generated and presented as well. A first platform may receive a question (mobile application) and a second different platform (e.g., virtual reality world with an avatar) may provide an answer to the question. In one instance, answers may be provided via the same platform that captured the question (e.g., a speaker captures the question and provides an answer after the system does the analysis). In another instance, answers are provided via the mobile application regardless of what platform captured the question (e.g., speaker and then mobile application). In yet another instance, answers are provided via the next accessed platform of the user regardless of what platform captured the questions. In each of these instances, security may be implemented (at least as discussed above) so that the answers are not readily accessible by any user who engages with the platform (e.g., a credential of the user who asked the question).

The formats database 164 is structured to define one or more aspects of one or more structures of data or formats of data. A “structure of data” can correspond to a shape of data, a type of data, a number of rows, columns, objects, or any combination thereof, or links or relationships among portions of the data. Additionally, a “structure of data” can correspond to a graph, a container of objects, a waveform, and/or a bit stream. A “format of data” can correspond to an order or composition of the data that indicates a type of the data. For example, a format can correspond to data types, such as image data, video data, audio data, virtual environment object data, and/or any combination thereof.

The security protocols database 166 are structured as one or more database repositories storing instructions that define one or more control criterion for one or more user interfaces for controlling the transition and use of user interfaces. For example, the security protocols database 166 can define a correspondence between one or more instances of user interfaces or types of user interfaces and one or more structures of data or formats of data compatible with those user interfaces. For example, the security protocols database 166 can indicate that a structure of data corresponding to a waveform is compatible with a speech system having a user interface corresponding to an audio input device or an audio output device (i.e., audio-to-audio correspondence). As another example, the provider system can identify that a query was received in audio format by a voice assistant, and can determine that a response is to be presented at least partially in audio format in a virtual environment as text-to-speech by referencing/utilizing the information stored in the security protocols database 166. For example, the provider system can identify that a query was received in audio format by a mobile device, and can determine that a response is to be presented at least partially in audio format in a virtual environment as text-to-speech. The security protocols database 166 can include a ranking that indicates an order of selection of a particular user interface for various output response formats according to various security restrictions associated with one or more user devices 103, client applications 174, or the remote computing system 104. For example, the security protocols database 166 can indicate that for a response having a structure corresponding to a virtual environment, a higher priority for selection of a user interface corresponding to a virtual environment and a lower priority for selection of a user interface corresponding to a mobile device. For example, the security protocols database 166 can store a table with table rows (one heuristic construct example is a table) including a column for priority of a given output, if a user or user account is associated with multiple user interfaces. For example, a heuristic can include a “1” in a row having a virtual environment identifier, to store a highest priority of output via the virtual environment. For example, a heuristic can include a “2” in a row having a tablet device identifier, to store a lower priority of output via the tablet device.

The security protocols 166 are rows of a table in one example, that store identifiers of various user devices 103, client applications 174, or any combination thereof, that are associated with one or more restrictions. For example, a restriction is a flag in a table that prevents or blocks transmission of account information to a user device 103 that is a voice assistant or a mobile device. The security protocols 166 include, in one example, a mobile device credential associated with the user device 103 of a specific user that authenticates the user's user device 103 to the user. The security protocols 166 include, in one example, a mobile app credential associated with the client application 174 of a specific user that authenticates the user's client application 174 to the user. The security protocols 166 include, in one example, a username, user password, or user token credential associated with a specific user that authenticates the user device 103 or the client application 174 to the user.

The presentation templates database 168 is structured as one or more databases or repositories that are structured to provide data to a user interface according to a presentation compatible with the user interface and the data. For example, the presentation templates database 168 can include instructions to embed particular text or media objects in particular virtual objects or at predetermined positions in the virtual environment, or to deliver images, audio, or video to a mobile device at particular positions in the user interface. For example, the presentation templates database 168 can control a position or an object in a user interface where particular data or a portion of particular data is presented, according to a response. For example, templates can correspond to rules, boundaries, or modular frameworks for rendering user interfaces, but are not limited thereto. Templates as discussed herein are not limited to objects having one or more fields that can be populated with data.

The user device(s) 103 is owned, operated, controlled, managed, and/or otherwise associated with a customer (e.g., a customer of the provider or financial institution). In some embodiments, the user device 103 may be or may include, for example, a desktop or laptop computer (e.g., a tablet computer), a smartphone, a wearable device (e.g., a smartwatch), a personal digital assistant, and/or any other suitable computing device. In the example shown, the user device 103 is structured as a mobile computing device, namely a smartphone. The user device 103 is located remotely from the provider computing system 102. Multiple user devices 103 are shown to indicate that each user may own or be associated with multiple user devices 103.

The user device 103 includes one or more I/O devices 170, a network interface 172, and one or more client applications 174. While the term “I/O” is used, it should be understood that the I/O devices 170 may be input-only devices, output-only devices, and/or a combination of input and output devices. In some instances, the I/O devices 170 include various devices that provide perceptible outputs (such as display devices with display screens and/or light sources for visually-perceptible elements, an audio speaker for audible elements, and haptics or vibration devices for perceptible signaling via touch, etc.), that capture ambient sights and sounds (such as digital cameras, microphones, etc.), and/or that allow the customer to provide inputs (such as a touchscreen display, stylus, keyboard, force sensor for sensing pressure on a display screen, etc.). In some instances, the I/O devices 170 further include one or more user interfaces (devices or components that interface with the customer), which may include one or more biometric sensors (such as a fingerprint reader, a heart monitor that detects cardiovascular signals, face scanner, an iris scanner, etc.). For example, an I/O device is a display device. The display device can display at least one or more user interfaces and can include an electronic display. An electronic display can include, for example, a liquid crystal display (LCD), a light-emitting diode (LED) display, an organic light-emitting diode (OLED) display, or the like. The display device can receive, for example, capacitive or resistive touch input. The user device 103 can include a I/O device 170.

In the example shown, the user device 103 includes a provider institution client application 174. The provider institution client application 174 may be provided by and at least partly supported by the provider computing system 102. In this regard, the client application 174 may be coupled to the provider computing system 102 may enable the customer to perform various customer activities (e.g., account management, tracking, etc.) and/or perform various transactions (e.g., transferring money between one or more accounts, paying various bills, etc.) associated with one or more customer accounts of the customer held at the provider associated with the provider computing system 102 (e.g., account opening and closing operations, fund transfers, etc.). In the example shown, the provider institution client application 174 may be a mobile banking application that enables various banking and resource management functionalities provided and supported by the provider computing system 102. In some instances, the client application 174 provided by the provider computing system 102 may additionally be coupled to the network 101 (e.g., via one or more application programming interfaces (APIs), webhooks, and/or software development kits (SDKs)) to integrate one or more features or services provided by the third-party content system 105. In some instances, the client application 174 may be provided as a web-based feature or application.

The I/O device 170 can be presentable on a display device operatively coupled with or integrated with the user device 103. The I/O device 170 can output at least one or more user interface presentations via a display device and control affordances. For example, a user interface can encompass a display device, an input device including a touch input device, an audio device to generate audio output, or any combination thereof. For example, the I/O device 170 can activate one or more of these components to output a graphical user interface (GUI) including one or more visual elements than can be selected by the touch input device or visually presented by the display device. The I/O device 170 can generate any physical phenomena detectable by human senses, including, but not limited to, one or more visual outputs, audio outputs, haptic outputs, or any combination thereof.

The remote computing system 104 is, in one example, a computing system located remotely from the provider computing system 102 and distinct from the user device 103. For example, the remote computing system 104 can correspond to a cloud system, a server, a distributed remote system, or any combination thereof. For example, the remote server 104 can include an operating system to execute a virtual environment. The operating system can include hardware control instructions and program execution instructions. The operating system can include a high-level operating system, a server operating system, an embedded operating system, or a boot loader. The remote computing system 104 can include a I/O device 171. The I/O device 171 can correspond at least partially to one or more of structure and operation to the I/O device 170, and can be distinct from the I/O device 170. For example, the remote computing system 104 is a server including hardware and software to provide an operating environment associated with a user or user account. For example, the remote computing system 104 is a server operated by a third-party entity and is directed to executing an application to provide an AR/VR environment.

One or more of the interface controller 112, the query processor 120, the AI processing circuit 130, the UI attributes circuit 140, and the presentation circuit 150 can be independent circuits or processors from the system processor 110, or can be integrated with the system processor 110 as various cores, dedicated processors, processing blocks, or any combination thereof.

The third-party content system 105 is, in one example, a computing system located remotely from the provider computing system 102 and the remote computing system 104, and distinct from the user device 103. The third-party content system 105 can be connected with the provider computing system 102 by the network 101, and can communicate bidirectionally with the provider computing system 102 by an Internet connection over the network 101. For example, the third-party content system 105 is a server hosting a real estate application or is a dedicated real estate server that provides real estate information as discussed herein. The third-party content system 105 is not limited to real estate information, and can be any server or website that can communicate with the provider computing system 102 by the network 101 or any other communication channel. The third-party content system includes I/O device 173. The I/O device 173 can correspond at least partially to one or more of structure and operation to the I/O device 170, and can be distinct from the I/O devices 170 and 171. For example, the I/O device 173 can include one or more network interfaces configured according to a protocol to serve an API that enables communication with a virtual environment executable or executing at the third-party content system.

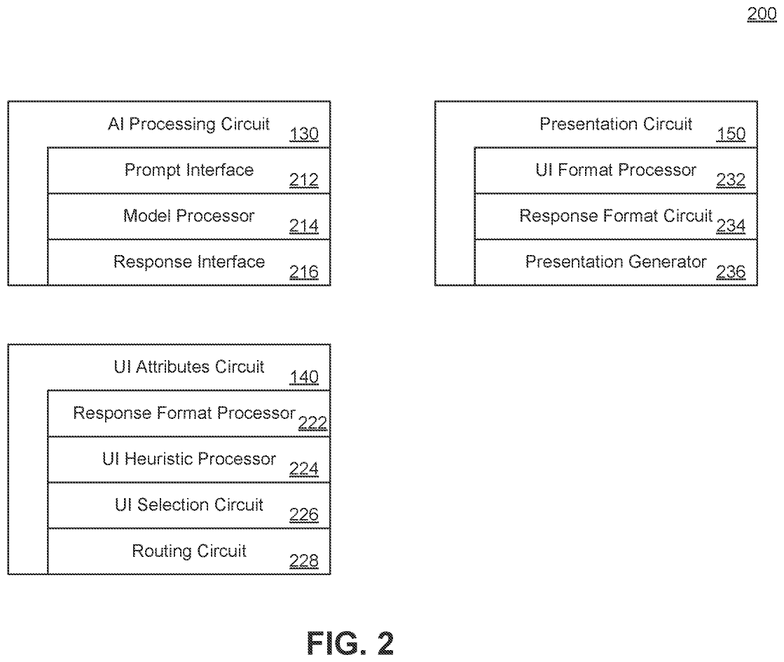

Based on the foregoing, FIG. 2 depicts an example system circuit architecture of various systems and/or components of the provider institution/provider computing system 102, according to an example embodiment. As illustrated by way of example in FIG. 2, an example system circuit architecture 200 can include at least the AI processing circuit 130, the UI attributes circuit 140, and the presentation circuit 150.

The AI processing circuit 130 can include a prompt interface 212, a model processor 214, and a response interface 216. The prompt interface 212 can receive and modify one or more queries based on one or more criteria. For example, the prompt interface 212 can modify a structure of data corresponding to a query to correspond to a model according to the model processor 214. For example, the prompt interface 212 can receive a text input by the touch input device and provide the text input to the query processor 120. For example, the prompt interface 212 can modify a natural language portion of the text input to correspond to a generative artificial intelligence model. For example, the prompt interface 212 can receive an audio input and modify a waveform of the audio input to correspond to a speech-to-text model. For example, the prompt interface 212 can receive an image input and modify a resolution or feature of the image input to correspond to a generative artificial intelligence model. The prompt interface 212 can modify or identify a query to include one or more indications of a structure of the data of the query or a format of the query. For example, the prompt interface 212 can detect one or both of the structure of the data of the query and the format of the query, and can create one or more query attributes indicative of the structure of the data of the query or the format of the query. The prompt interface 212 can, for example, transmit to the model processor 214 or the response interface 216 the query attributes along with the query or embedded in the query.

The prompt interface 212, the model processor 214, and the response interface 216 are illustrated by way of example as distinct from each other and from the various components of the computing system 100. However, one or more of the prompt interface 212, the model processor 214, and the response interface 216 can be integrated with each other or other components of the computing system 100. For example, the one or more of the prompt interface 212, the model processor 214, and the response interface 216 are integrated into or allocated to various processors or cores of processors of the AI processing circuit 130. For example, the one or more of the prompt interface 212, the model processor 214, and the response interface 216 are integrated into or allocated to various cores of the system processor 110.

The model processor 214 can select and execute one or more models according to one or more artificial intelligence systems. The model processor 214 can execute a model to generate a response corresponding to a query, according to one or more aspects of the model. For example, the model processor 214 can generate a response to a query having particular data or a structure of data indicated by or caused by the query. For example, the model processor 214 can receive a query from the prompt interface 212 requesting historical spending data for a particular user over a particular time period. In response, the model processor 214 can generate text via a generative AI model that summarizes historical spending data for the particular user over the particular time period. In response, the model processor 214 can generate image or video data via a generative AI model that summarizes indicates via one or more charts, graphs, or visualizations, the historical spending data for the particular user over the particular time period. The model processor 214 can generate one or more responses, and is not limited to any number or type of responses or any number or type of models used for a query.

The response interface 216 is structured or configured to modify or identify a response to include one or more indications of a structure of the data of the response or a format of the response. For example, the response interface 216 can detect one or both of the structure of the data of the response and the format of the response, and can create one or more response attributes indicative of the structure of the data of the response or the format of the response. The response interface 216 can, for example, transmit the response attributes with the response or embedded in the response to the UI attributes circuit 140 or any component thereof.

The UI attributes circuit 140 can include a response format processor 222, a UI heuristic processor 224, a UI selection circuit 226, or a routing circuit 228. The response format processor 222 is structured or configured to receive a response and can identify one or more response attributes indicative of the structure of the data of the response or the format of the response. For example, the response format processor 222 can identify a particular format corresponding to a response, based on one or more response attributes corresponding to the response. The response format processor 222 can transmit the response attributes or the identified formats to the UI heuristic processor 224.

The response format processor 222, the UI heuristic processor 224, the UI selection circuit 226, and the routing circuit 228 are illustrated by way of example as distinct from each other and from the various components of the computing system 100. However, one or more of the response format processor 222, the UI heuristic processor 224, the UI selection circuit 226, and the routing circuit 228 can be integrated with each other or other components of the computing system 100. For example, the one or more of the response format processor 222, the UI heuristic processor 224, the UI selection circuit 226, and the routing circuit 228 are integrated into or allocated to various processors or cores of processors of the AI processing circuit 130. For example, the one or more of the response format processor 222, the UI heuristic processor 224, the UI selection circuit 226, and the routing circuit 228 are integrated into or allocated to various cores of the system processor 110.

The UI heuristic processor or circuit 224 is structured or configured to compare one or more attributes with one or more heuristics and determine whether the one or more attributes satisfy one or more heuristics. For example, the UI heuristic processor 224 can obtain one or more response attributes corresponding to a response, and can determine whether the response attributes satisfy one or more security protocols as discussed above. For example, the UI heuristic processor 224 can select one or more security protocols corresponding to user interfaces or types of user interfaces associated with a profile of a user as discussed above. For example, the UI heuristic processor 224 can receive an indication of a user or a profile of a user, and can identify one or more user interfaces or types of user interfaces associated with the profile of the user. The UI heuristic processor 224 can then compare the response attributes with heuristics corresponding to one or more of the user interfaces or types of user interfaces associated with the profile of the user as discussed above. The UI heuristic processor 224 can transmit to the UI selection circuit 226 one or more indications of one or more user interfaces or types of user interfaces that satisfy the response attributes as discussed above. The UI heuristic processor 224 can transmit to the UI selection circuit 226 one or more indications of one or more user interfaces or types of user interfaces that do not satisfy the response attributes as discussed above.

The UI selection circuit 226 can select one or more user interfaces corresponding to the determinations of the UI heuristic processor 224. For example, the UI selection circuit 226 can identify a user interface corresponding to a user by determining that a user interface associated with a profile of the user corresponds to or matches an indication of a user interface or type of user interface that matches a UI heuristic. For example, the UI selection circuit 226 can determine that a virtual environment user interface is associated with a profile of a user by a table relationship as discussed above, and can determine that response attributes of a response satisfy a UI heuristic corresponding to a virtual environment associated with the profile of the user. The UI selection circuit 226 can determine an order of a plurality of user interfaces, where a plurality of user interfaces satisfy the UI heuristic. For example, a profile of a user can be associated with a mobile device user interface compatible with text output as discussed above, a virtual environment user interface compatible with text output, and a mobile device user interface compatible with text output having fewer characters than the virtual environment user interface. The UI selection circuit 226 can select only the virtual environment user interface, or can rank the virtual environment user interface over the mobile device user interface for transmission of the response via the routing circuit 228.

The routing circuit 228 can provide the response to one or more user interfaces, or provide instructions for one or more user interfaces to generate output corresponding to the response. For example, the routing circuit 228 can identify one or more user interfaces corresponding to one or more satisfied security protocols, and can transmit at least a portion of the response to the corresponding selected user interfaces. For example, the routing circuit 228 can transmit the response to the virtual environment user interface, and can transmit a portion of the response to the client application 174 of the user device 103. For example, the portion of the response can correspond to a “preview” of the response and an indication to receive the full response at the mobile device user interface. As one example, the routing circuit 228 transmits the first sentence of a text response to the client application 174 of the user device 103, and provides a link via a push notification to consume the entirety or the remainder of the sentences of the response in a virtual environment, where the virtual environment is authorized to present the entirety or the remainder of the sentences according to the security protocols. As another example, the routing circuit 228 transmits the first sentence of a text response to the client application 174 of the user device 103, and provides a push notification to identify a tablet device where the user can consume the entirety or the remainder of the sentences of the response, where the table is authorized to present the remainder of the sentences according to the security protocols. As still another example, the routing circuit 228 transmits the first sentence of a text response to the client application 174 of the user device 103, and provides a push notification to identify a tablet device where the user can consume charts generated as part of the response, where the tablet is authorized to present the remainder of the sentences according to the security protocols. The provider computing system can determine that charts including account information, or charts generally, are restricted to presentation at devices that have not been detected to leave the geofence corresponding to a home area of the user, according to the security protocols.

The presentation circuit 150 can include a UI format processor 232, a response format circuit 234, and a presentation generator 236. The UI format processor 232, the response format circuit 234, and the presentation generator 236 are illustrated by way of example as distinct from each other and from the various components of the computing system 100. However, one or more of the UI format processor 232, the response format circuit 234, and the presentation generator 236 can be integrated with each other or other components of the computing system 100. For example, the one or more of the UI format processor 232, the response format circuit 234, and the presentation generator 236 may be integrated into or allocated to various processors or cores of processors of the AI processing circuit 130. For example, the one or more of the UI format processor 232, the response format circuit 234, and the presentation generator 236 are integrated into or allocated to various cores of the system processor 110.

The UI format processor or circuit 232 can structure the response according to one or more security protocols and, particularly, to the recipient user interface and associated devices based on the recipient devices and/or content of the response. For example, the UI format processor 232 can receive a response and an indication of at least one user interface. The UI format processor 232 can modify the structure of the data of the response or the format of the response to correspond to the indicated user interface. For example, the UI format processor 232 can receive a response including data having a structure corresponding to text. The UI format processor 232 can generate a second structure of data or modify the structure of the data of the response to a portion of the text, to correspond to output of the response in accordance with a character limit of a user interface field of a mobile device.

The response format circuit 234 can structure the response according to one or more formats. For example, the response format circuit 234 can receive a response and an indication of at least one user interface. The response format circuit 234 can modify a structure of the data of the response or a format of the response to correspond to the user-indicated user interface. For example, the response format circuit 234 can receive a response including data having a structure corresponding to text. The response format circuit 234 can generate a second structure of data or modify the structure of the response data to audio, to correspond to output of the response in accordance with an avatar in a virtual environment. The presentation generator 236 can create one or more outputs corresponding to the response in accordance with the one or more formats associated with the selected one or more user interface output devices for the response. For example, the presentation generator 236 can generate or cause a user interface to generate an output corresponding to a response according to of the selected one or more user interfaces (e.g., a mobile device display device (user interface) may be smaller and different requirements relative to a laptop display device).

Thus, the provider system can select, according to a determination that a structure of the second data satisfies a third format distinct from the first format, the second user interface corresponding to the second format that satisfies the structure of the second data. For example, the provider system can cause, according to the determination that the structure of the second data satisfies the heuristic corresponding to the second format, the first user interface to present an indication corresponding to the second user interface. For example, the provider system can select, according to a determination that the second user interface is associated with the profile of the user, the second user interface. For example, the provider system can exclude, according to a determination that a structure of the second data satisfies a third format distinct from a second heuristic corresponding to the first format, the first user interface from presenting at least the portion of the second data. For example, the provider system can include the heuristic indicating a type of presentation associated with a type of the second user interface. For example, the provider system can include the type of presentation corresponding to at least one of a visual presentation or an audio presentation. For example, the provider system can include the type of the second user interface corresponding to at least one of a graphical user interface (GUI) or a virtual reality interface. For example, the provider system can include the type of the first user interface corresponding to a voice recognition interface. The processor can select, according to a determination that a structure of the second data satisfies a third format distinct from the first format, the second user interface corresponding to the second format that satisfies the structure of the second data.

Based on the foregoing, pictorial representations of continuous interactions between and among various user devices are shown according to example embodiments herein.

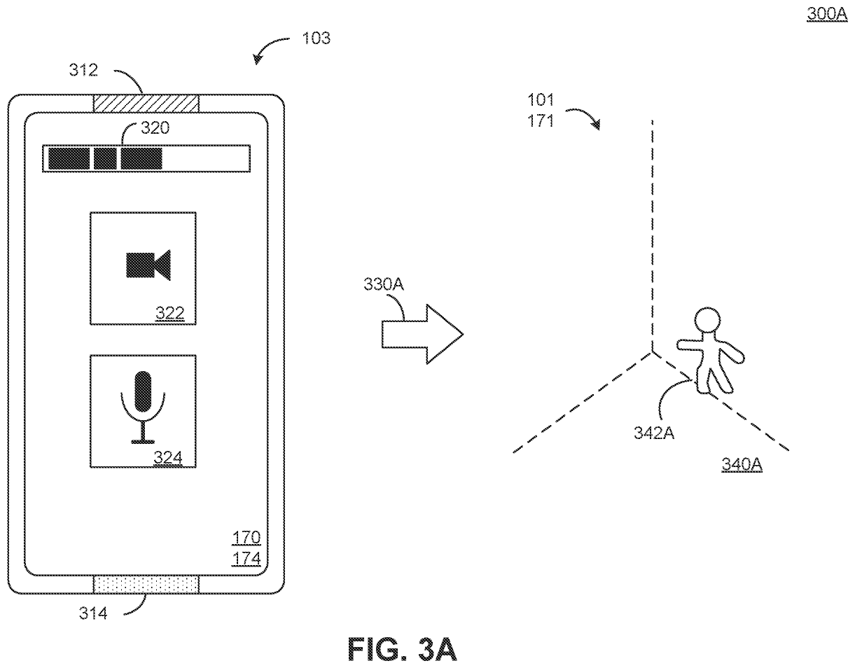

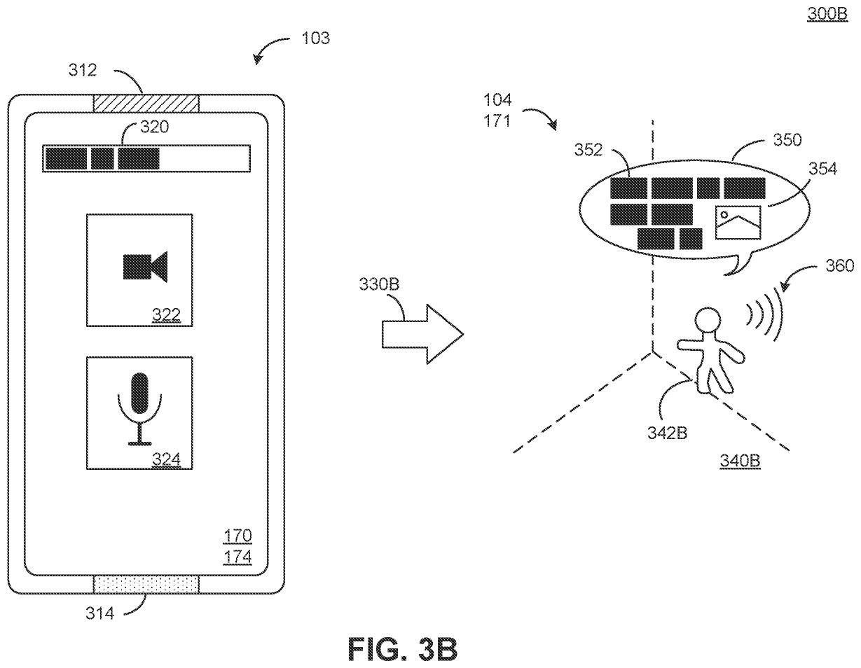

Based on the foregoing, referring next to FIG. 3A, an example input state of a first multimodal user interface environment is shown, according to an example embodiment. As illustrated by way of example in FIG. 3A, an example input state of a first multimodal user interface environment 300A can include at least the mobile device 103, a text input affordance 320, a video input affordance 322, and an audio input affordance 324, a user interface selection action 330A, and a virtual environment 340A. In this example, the user device 103 is a mobile device, such as a smartphone, and the remote device 104 that provides a virtual reality environment 340A via the client application 174.

The mobile device 103 is shown to include a camera input device 312 and an audio input-output device 314. The camera input device 312 can correspond to an image or video capture device. For example, the camera input device 312 can correspond to a front-facing camera of a mobile device, and can be configured to capture data structured or formatted according to image data, video data, text data. The audio input-output device 314 can correspond to a sound capture device. For example, the audio input-output device 314 can correspond to a microphone, and can be configured to capture data structured or formatted according to raw or compressed audio. For example, the audio input-output device 314 can correspond to a speaker, and can be configured to output audio.

The text input affordance 320 can correspond to a portion of the user interface environment 300A (e.g., graphical user interface) configured to receive at least a textual input. For example, the text input affordance 320 can correspond to a text input field of a GUI. The video input affordance 322 can correspond to a portion of the user interface environment 300A configured to activate the camera input device 312 to capture image or video data of a GUI of the mobile device 103. For example, the video input affordance 322 can correspond to a button that can be pressed, toggled, or held to activate input. The audio input affordance 324 can correspond to a portion of the user interface environment 300A configured to activate the audio input-output device 314 to sound or audio data. For example, the audio input affordance 324 can correspond to a button that can be pressed, toggled, or held to activate input. For example, the GUI discussed herein is a component of the client application 174.

The user interface selection action 330A (e.g., button, switch, selection icon, etc.) can correspond to initiation of a transition of an interaction from the mobile device 103 to the remote computing system 104 via the network 101 that is configured to present a virtual environment 340A. For example, the user interface selection action 330A can correspond to a state before presentation of a response. The virtual environment 340A can correspond to a rendered environment including one or more virtual avatars, objects, places, or any combination thereof. The virtual environment 340A can, for example, include an avatar 342A configured to provide a presentation corresponding to a response. For example, the avatar 342A correspond to a state before presentation of a response.

Based on the foregoing, referring next to FIG. 3B, an example handoff state of a first multimodal user interface environment is shown, according to an example embodiment. As illustrated by way of example in FIG. 3B, an example handoff state of a first multimodal user interface environment 300B can include at least a user interface handoff action 330B, and a virtual environment 340B. The user interface handoff action 330B can correspond to completion of a transition of an interaction from the mobile device 103 to the virtual environment 340B of the VR device. For example, the user interface handoff action 330B can correspond to a state during presentation of a response.

The virtual environment 340B can correspond to a rendered environment including one or more virtual avatars, objects, places, or any combination thereof. The virtual environment 340A can, for example, include an avatar 340B configured to provide a presentation corresponding to a response. For example, the avatar 342B correspond to a state during presentation of a response. The virtual environment 340B can include a response presentation 350. The response presentation 350 can present one or more portions of the response according to the security protocols and the formats of the virtual environment 340. The response presentation 350 can include a one or more of a text presentation 352 and a multimedia presentation 354. The text presentation 352 can include a portion of the response corresponding to text. The multimedia presentation 354 can include a portion of the response corresponding to image or video. For example, the virtual environment 340B can present the response presentation 350 to a portion of the user interface based on a position or posture of the avatar 342B.

The virtual environment 340B can generate an audio output 360 corresponding to the response. For example, the virtual environment 340B can generate audible speech corresponding to one or more of the text presentation 352 and the multimedia presentation 354. For example, the virtual environment 340B can render the avatar 342B to appear to speak according to the audio output 360. For example, the provider computing system 102 can determine that the virtual environment 340A is authorized to present the response presentation 350 and the audio output 360, according to one or more of the security protocols 166.

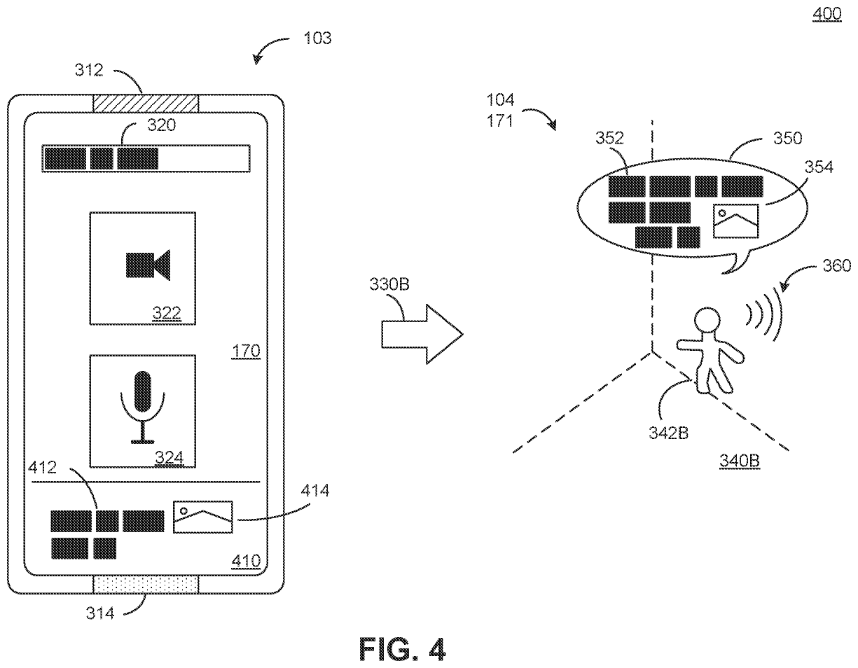

FIG. 4 depicts an example output state of a first multimodal user interface environment, according to an example embodiment. As illustrated by way of example in FIG. 4, an example output state of a first multimodal user interface environment 400 can include at least a local response presentation response output 410. In one example, the first multimodal user interface environment 400 is a first user device 103 corresponding to a mobile device and running a first client application 174, and a second user device 103 corresponding to a remote computing system 104 executing a virtual environment as discussed herein. In this example, a user can submit a query via the client application 174 of the mobile device 103, and can receive a message corresponding to at least a portion of a response to the query at the mobile device 103. The user can also receive a notification at the mobile device 103 that content corresponding to at least a portion of the response is available to be consumed at a virtual environment associated with the user. The provider computing system 102 can perform the user handoff action 300B according to its determination that the portion of the response is restricted from presentation at the mobile device 103 according to one or more security protocols 166 as discussed herein.

The local response output 410 can correspond to a portion of the user interface of the mobile device 103 configured to present at least a portion of the response. For example, the local response presentation 410 can include the response or portion thereof, and can include an indication, or a link to the virtual environment 340B that includes the response in full. The local response output 410 is thus a preview of a fuller response to a received query/input. The local response output 410 can include a text presentation 412 and a media presentation 414. The text presentation 412 can include a portion of the response corresponding to text, or an indication of the response rendered as text. For example, the text presentation 412 can include text directing a user to follow a link to consume the response in the virtual environment 340B or via the avatar 342B. For example, the text presentation 412 can direct the user to the avatar 342B.

The media presentation 414 can include a portion of the response corresponding to image, video, or audio, or an indication of the response rendered as an image, video, or audio. For example, the media presentation 414 can include an image or a video directing a user to follow a link to consume the response at the virtual environment 340B or via the avatar 342B. For example, the media presentation 414 can include audio output directing a user to follow a link to consume the response at the virtual environment 340B or via the avatar 342B. For example, the media presentation 412 can direct the user to the avatar 342B.

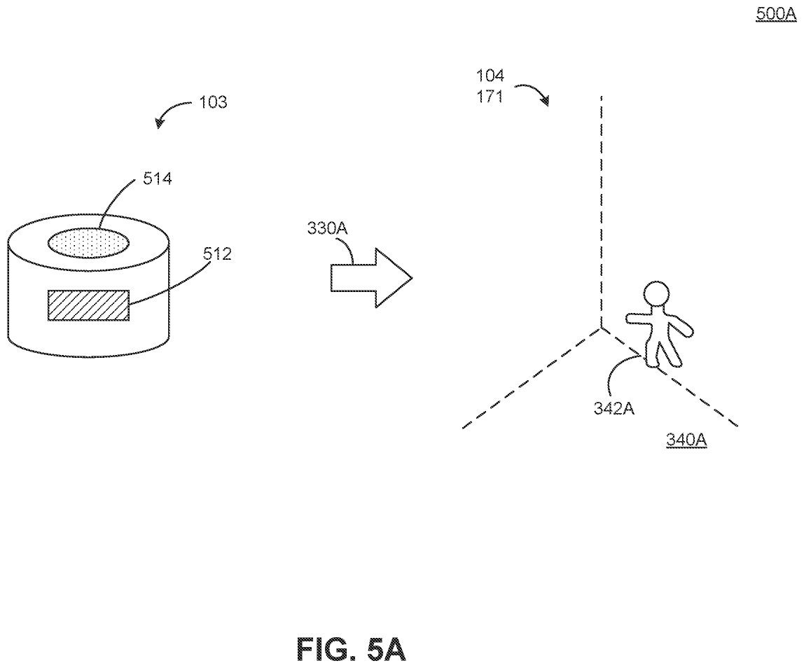

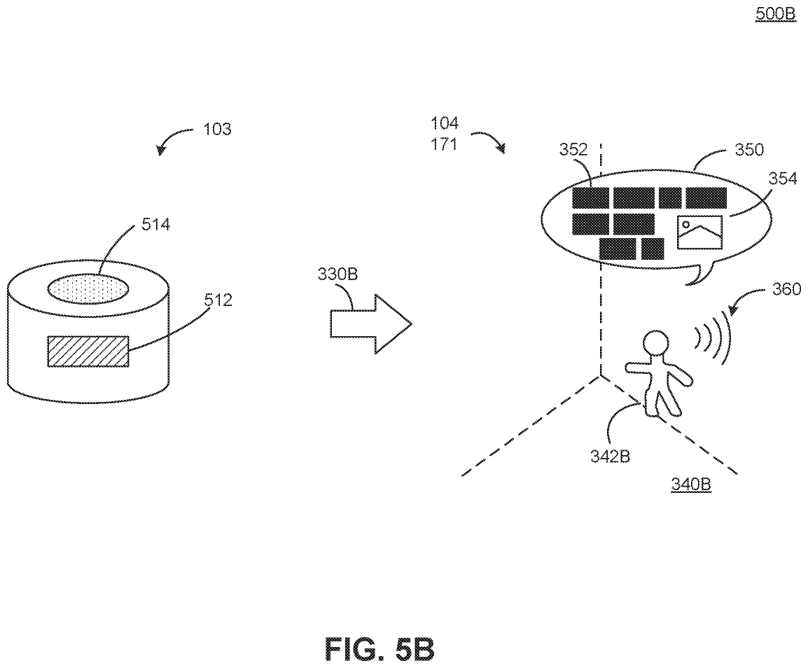

FIG. 5A depicts an example input state of a second multimodal user interface environment, according to an example embodiment. As illustrated by way of example in FIG. 5A, an example input state of a second multimodal user interface environment 500A can include at least a speech device according to the user device 103. In one example, the second multimodal user interface environment 500 is a first user device 103 corresponding to a voice assistant device and running a first client application 174, a second user device 103 corresponding to a remote computing system 104 executing a virtual environment as discussed herein, and a third user device 103 corresponding to a mobile device and running a third client application 174. In this example, a user can submit a query via the client application 174 of the voice assistant device 103, and can receive a message corresponding to at least a portion of a response to the query at the voice assistant device 103. The user can also receive a notification at the voice assistant device 103 that content corresponding to at least a portion of the response is available to be consumed at a virtual environment associated with the user. The user can also receive a notification at the voice assistant device 103 that content corresponding to at least a portion of the response is available to be consumed at the client application 174 of the mobile device 103 associated with the user. The provider computing system 102 can perform the user handoff action 300B according to its determination that the portion of the response is restricted from presentation at the voice assistant device 103 and the mobile device 103 according to one or more security protocols 166 as discussed herein. For example, the provider computing system 102 can determine that a voice assistant device is restricted from outputting account information according to a predetermined rule because the voice assistant device can be overheard easily by individuals other than the user of the voice assistant device 103.

The speech device 103 can correspond to a voice assistant or speech-recognition device. For example, the speech device 103 can be integrated into a home speaker, camera, monitor, security device, or any combination thereof. The speech device 103 can include a camera input device 512, and an audio input-output device 514. The camera input device 512 can correspond at least partially in one or more of structure and operation to the camera input device 312. The audio input-output device 514 can correspond at least partially in one or more of structure and operation to audio input-output device 314. For example, the speech device 103 can receive user input corresponding to a query via a microphone of the input-output device 514. The speech device 103 can transform the audio query into a text query, or cause the audio query to be transformed into a text query via a local or remote speech-to-text circuit coupled with the speech device 103. The speech device 103 can then cause the user interface selection action 330A.

FIG. 5B depicts an example handoff state of a second multimodal user interface environment, according to an example embodiment. As illustrated by way of example in FIG. 5B, an example handoff state of a second multimodal user interface environment 500B can include at least the speech device 103 and the virtual environment 340B. The speech device 103 can cause user interface handoff action 330B and cause the virtual environment 340B to present the response presentation 350 via the avatar 342B.

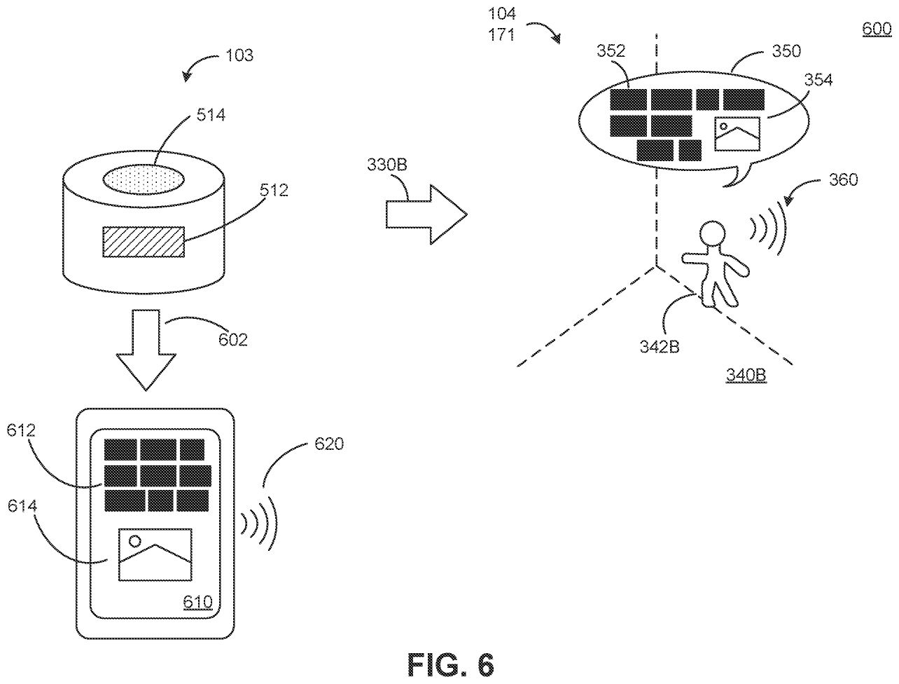

FIG. 6 depicts an example output state of a second multimodal user interface environment, according to an example embodiment. As illustrated by way of example in FIG. 6, an example output state of a second multimodal user interface environment 600 can include at least a second user interface handoff action 602. The second user interface handoff action 602 can correspond to completion of a transition of an interaction from a first user device 103 corresponding to a speech device (e.g., speech device 103) to a second user device 103 corresponding to a mobile device (e.g., mobile device 103), and can be distinct from the user interface handoff action 330B from the mobile device 103 to the virtual environment 340B of a VR device. For example, the user interface handoff action 330B can correspond to a state during presentation of a response in the virtual environment 340B.

For example, the mobile device 103 can present an alert presentation GUI 610 including a text output 612, a media output 614, and an audio output 620. For example, the mobile device 103 can present at least a portion of the alert GUI at a user interface of the mobile device 103 concurrently with readiness of the virtual environment 340B to present the response presentation 350 in a user interface of a VR device. For example, readiness can correspond to ability of a user interface to present a particular presentation, and is not limited to actual presentation. The text output 612 can correspond at least partially in one or more of structure and operation to the text presentation 412. The media output 614 can correspond at least partially in one or more of structure and operation to the media output 414. The audio presentation 620 can correspond at least partially in one or more of structure and operation to the audio output of the media output 414.

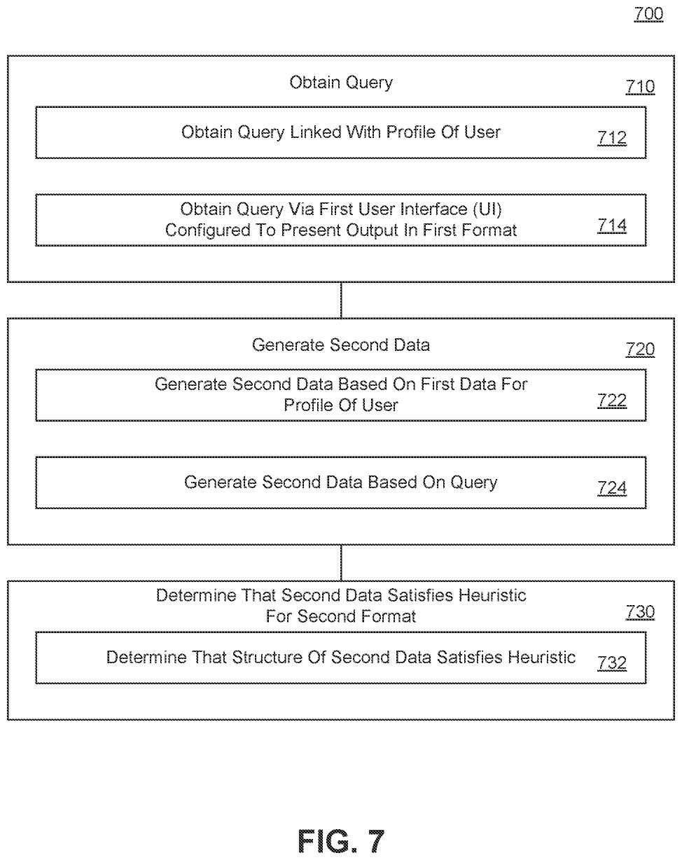

Referring now to FIG. 7, a method of providing responses among and between a plurality of user interfaces based on a structure of user input is shown, according to an example embodiment. As described herein, various systems and components of the provider system 100 may perform the method 700.

At process 710, a query is obtained or received (e.g., a question, an input, etc.). For example, the query processor 120 (of the provider computing system 102) obtains the query. At process 712, the provider computing system 102 obtains the query associated with or associated with a profile of a user. At process 714, the provider computing system 102 obtains the query via a first user interface configured to present an output in a first format. For example, when the input is a voice query, the first user interface of the user device 103 may include a voice recognition interface that receives the voice query. Here, the first format is an audio format that can include an audio capture file format including a representation of a waveform of the audio being captured by the voice assistant device. At process 720, the provider computing system 102 generates the second data. For example, second data is a response to a query including a text response, and a chart object describing performance for accounts identified in the user's query. At process 722, the provider computing system 102 generates the second data based on first data for the profile of the user. At process 724, the provider computing system 102 generates the second data based on the query. At process 730, the provider computing system 102 determines whether the second data satisfies a heuristic for a second format. In particular, the UI attributes circuit 140 of the provider computing system 102 is configured or structured to determine that the second data satisfies a heuristic for a second format. For example, the second data, having data of a response including a chart and text, can satisfy a heuristic that is configured to restrict presentation of sensitive content of the response to particular types of user devices 103. Here, the provider computing system determines, in an example, whether the content from the response is authorized to be presented at a virtual environment. The provider computing system 102 determines that the content from the response is authorized to be presented at a virtual environment, based on security protocols that control which types of content can be presented at which types of user device 103 in this instance. At process 732, the provider computing system 102 determines that a structure of the second data satisfies the heuristic. For example, the method can include the heuristic indicating a type of presentation associated with a type of the second user interface. The second user interface may be the GUI 610 and the presentation may be the text output 612 and the media output 614. For example, the method can include the type of presentation corresponding to at least one of a visual presentation or an audio presentation.

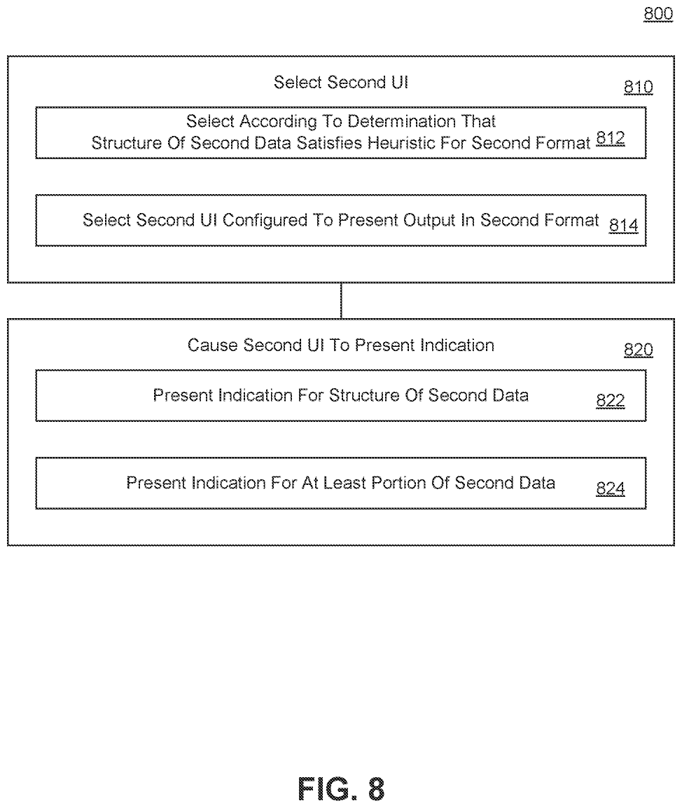

FIG. 8 depicts an example method of providing responses among a plurality of user interfaces based on a structure of user input, according to an example embodiment. At least the provider system 100 or any component thereof can perform method 800. At 810, a second UI configured to present output in the second format is selected. For example, the presentation circuit 150 can select the second UI. For example, the method can include selecting, according to a determination that the second user interface is associated with the profile of the user, the second user interface. At 812, the second UI is selected according to the determination that the structure of the second data satisfies the heuristic for the second format. For example, the method can include causing, according to the determination that the structure of the second data satisfies the heuristic corresponding to the second format, the first user interface to present an indication corresponding to the second user interface. At 814, the second UI configured to present output in the second format is selected.

For example, the method can include selecting, according to a determination that a structure of the second data satisfies a third format distinct from the first format, the second user interface corresponding to the second format that satisfies the structure of the second data. For example, the presentation circuit 150 can select the second user interface as discussed herein. For example, the method can exclude, according to a determination that a structure of the second data satisfies a third format distinct from a second heuristic corresponding to the first format, the first user interface from presenting at least the portion of the second data. For example, the presentation circuit 150 can exclude the first user interface as discussed herein.

At 820, the method 800 can cause the second UI to present an indication. For example, the presentation circuit 150 can cause the second UI to present the indication. For example, the method can include the type of the second user interface corresponding to at least one of a graphical user interface (GUI) or a virtual reality interface. At 822, the method 800 can present an indication for the structure of the second data. At 824, the method 800 can present an indication for at least a portion of the second data.

The embodiments described herein have been described with reference to drawings. The drawings illustrate certain details of specific embodiments that implement the provider systems, methods and programs described herein. However, describing the embodiments with drawings should not be construed as imposing on the disclosure any limitations that may be present in the drawings.

It should be understood that no claim element herein is to be construed under the provisions of 35 U.S.C. § 112(f), unless the element is expressly recited using the phrase “means for.”

Any foregoing references to currency or funds are intended to include fiat currencies, non-fiat currencies (e.g., precious metals), and math-based currencies (often referred to as cryptocurrencies). Examples of math-based currencies include Bitcoin, Litecoin, Dogecoin, and the like.

As used herein, the term “circuit” may include hardware structured to execute the functions described herein. In some embodiments, each respective “circuit” may include machine-readable media for configuring the hardware to execute the functions described herein. The circuit may be embodied as one or more circuitry components including, but not limited to, processing circuitry, network interfaces, peripheral devices, input devices, output devices, sensors, etc. In some embodiments, a circuit may take the form of one or more analog circuits, electronic circuits (e.g., integrated circuits (IC), discrete circuits, system on a chip (SOC) circuits), telecommunication circuits, hybrid circuits, and any other type of “circuit.” In this regard, the “circuit” may include any type of component for accomplishing or facilitating achievement of the operations described herein. For example, a circuit as described herein may include one or more transistors, logic gates (e.g., NAND, AND, NOR, OR, XOR, NOT, XNOR), resistors, multiplexers, registers, capacitors, inductors, diodes, wiring, and so on.

The “circuit” may also include one or more processors communicatively coupled to one or more memory or memory devices. In this regard, the one or more processors may execute instructions stored in the memory or may execute instructions otherwise accessible to the one or more processors. In some embodiments, the one or more processors may be embodied in various ways. The one or more processors may be constructed in a manner sufficient to perform at least the operations described herein. In some embodiments, the one or more processors may be shared by multiple circuits (e.g., circuit A and circuit B may comprise or otherwise share the same processor which, in some example embodiments, may execute instructions stored, or otherwise accessed, via different areas of memory). Alternatively or additionally, the one or more processors may be structured to perform or otherwise execute certain operations independent of one or more co-processors. In other example embodiments, two or more processors may be coupled via a bus to enable independent, parallel, pipelined, or multi-threaded instruction execution. Each processor may be implemented as one or more general-purpose processors, application specific integrated circuits (ASICs), field programmable gate arrays (FPGAs), digital signal processors (DSPs), or other suitable electronic data processing components structured to execute instructions provided by memory. The one or more processors may take the form of a single core processor, multi-core processor (e.g., a dual core processor, triple core processor, quad core processor), microprocessor, etc. In some embodiments, the one or more processors may be external to the apparatus, for example the one or more processors may be a remote processor (e.g., a cloud-based processor). Alternatively or additionally, the one or more processors may be internal and/or local to the apparatus. In this regard, a given circuit or components thereof may be disposed locally (e.g., as part of a local server, a local computing system) or remotely (e.g., as part of a remote server such as a cloud-based server). To that end, a “circuit” as described herein may include components that are distributed across one or more locations.

An exemplary system for implementing the overall system or portions of the embodiments might include a general purpose computing devices in the form of computers, including a processing unit, a system memory, and a system bus that couples various system components including the system memory to the processing unit. Each memory device may include non-transient volatile storage media, non-volatile storage media, non-transitory storage media (e.g., one or more volatile and/or non-volatile memories), etc. In some embodiments, the non-volatile media may take the form of ROM, flash memory (e.g., flash memory such as NAND, 3D NAND, NOR, 3D NOR), EEPROM, MRAM, magnetic storage, hard discs, optical discs, etc. In other embodiments, the volatile storage media may take the form of RAM, TRAM, ZRAM, etc. Combinations of the above are also included within the scope of machine-readable media. In this regard, machine-executable instructions comprise, for example, instructions and data which cause a general purpose computer, special purpose computer, or special purpose processing machines to perform a certain function or group of functions. Each respective memory device may be operable to maintain or otherwise store information relating to the operations performed by one or more associated circuits, including processor instructions and related data (e.g., database components, object code components, script components), in accordance with the example embodiments described herein.

It should also be noted that the term “input devices,” as described herein, may include any type of input device including, but not limited to, a keyboard, a keypad, a mouse, joystick, or other input devices performing a similar function. Comparatively, the term “output device,” as described herein, may include any type of output device including, but not limited to, a computer monitor, printer, facsimile machine, or other output devices performing a similar function.

The phraseology and terminology used herein is for the purpose of description and should not be regarded as limiting. The use of “including,” “comprising,” “having,” “containing,” “involving,” “characterized by,” “characterized in that,” and variations thereof herein, is meant to encompass the items listed thereafter, equivalents thereof, and additional items, as well as alternate implementations consisting of the items listed thereafter exclusively. In one implementation, the systems and methods described herein consist of one, each combination of more than one, or all of the described elements, acts, or components.

References to “or” may be construed as inclusive so that any terms described using “or” may indicate any of a single, more than one, and all of the described terms. References to at least one of a conjunctive list of terms may be construed as an inclusive OR to indicate any of a single, more than one, and all of the described terms. For example, a reference to “at least one of ‘A’ and ‘B’” can include only ‘A’, only ‘B’, as well as both “A’ and ‘B’. Such references used in conjunction with “comprising” or other open terminology can include additional items. References to “is” or “are” may be construed as nonlimiting to the implementation or action referenced in connection with that term. The terms “is” or “are” or any tense or derivative thereof, are interchangeable and synonymous with “can be” as used herein, unless stated otherwise herein.

Directional indicators depicted herein are example directions to facilitate understanding of the examples discussed herein, and are not limited to the directional indicators depicted herein. Any directional indicator depicted herein can be modified to the reverse direction, or can be modified to include both the depicted direction and a direction reverse to the depicted direction, unless stated otherwise herein. While operations are depicted in the drawings in a particular order, such operations are not required to be performed in the particular order shown or in sequential order, and all illustrated operations are not required to be performed. Actions described herein can be performed in a different order. Where technical features in the drawings, detailed description or any claim are followed by reference signs, the reference signs have been included to increase the intelligibility of the drawings, detailed description, and claims. Accordingly, neither the reference signs nor their absence have any limiting effect on the scope of any claim elements.

Scope of the systems and methods described herein is thus indicated by the appended claims, rather than the foregoing description. The scope of the claims includes equivalents to the meaning and scope of the appended claims.

What is claimed is:

1. A system, comprising:
at least one processing circuit comprising at least one memory storing instructions therein that are executable by one or more processors to:
obtain, via a first user interface, a query associated with a profile of a user, the first user interface configured to present an output corresponding to a first format;
generate, based on the query and first data corresponding to the profile of the user, second data as a response to the query;
select, according to a determination that a structure of the second data satisfies a heuristic corresponding to a second format, a second user interface configured to present an output corresponding to the selected second format; and
cause the second user interface to present an output in the selected second format corresponding to at least a portion of the second data.

2. The system of claim 1, the processors to:
select, according to a determination that a structure of the second data satisfies a third format distinct from the first format, the second user interface corresponding to the second format that satisfies the structure of the second data.

3. The system of claim 1, the processors to:
cause, according to the determination that the structure of the second data satisfies the heuristic corresponding to the second format, the first user interface to present an indication corresponding to the second user interface.

4. The system of claim 1, the processors to:
select, according to a determination that the second user interface is associated with the profile of the user, the second user interface.

5. The system of claim 1, the processors to:
exclude, according to a determination that a structure of the second data does not satisfy a second heuristic corresponding to the first format, the first user interface from presenting at least the portion of the second data.

6. The system of claim 1, the heuristic indicating a type of presentation associated with a type of the second user interface.

7. The system of claim 6, the type of presentation corresponding to at least one of a visual presentation or an audio presentation.

8. The system of claim 6, the type of the second user interface corresponding to at least one of a graphical user interface (GUI) or a virtual reality interface.

9. The system of claim 1, the type of the first user interface corresponding to a voice recognition interface.

10. A method, comprising:
obtaining, via a first user interface, a query associated with a profile of a user, the first user interface configured to present output corresponding to a first format;
generating, based on the query and first data corresponding to the profile of the user, second data as a response to the query;
selecting, according to a determination that a structure of the second data satisfies a heuristic corresponding to a second format, a second user interface configured to present output corresponding to the selected second format; and
causing the second user interface to present an output in the selected second format corresponding to at least a portion of the second data.

11. The method of claim 10, further comprising:
selecting, according to a determination that a structure of the second data satisfies a third format distinct from the first format, the second user interface corresponding to the second format that satisfies the structure of the second data.

12. The method of claim 10, further comprising:
causing, according to the determination that the structure of the second data satisfies the heuristic corresponding to the second format, the first user interface to present an indication corresponding to the second user interface.

13. The method of claim 10, further comprising:
selecting, according to a determination that the second user interface is associated with the profile of the user, the second user interface.

14. The method of claim 10, further comprising:
excluding, according to a determination that a structure of the second data does not satisfy a second heuristic corresponding to the first format, the first user interface from presenting at least the portion of the second data.

15. The method of claim 10, the heuristic indicating a type of presentation associated with a type of the second user interface.

16. The method of claim 15, the type of presentation corresponding to at least one of a visual presentation or an audio presentation.

17. The method of claim 15, the type of the second user interface corresponding to at least one of a graphical user interface (GUI) or a virtual reality interface.

18. The method of claim 10, the type of the first user interface corresponding to a voice recognition interface.

19. A non-transitory computer readable medium storing instruction that, when executed by one or more processors, cause the one or more processors to perform operations comprising:
obtaining, via a first user interface, a query associated with a profile of a user, the first user interface configured to present output corresponding to a first format;
generating, based on the query and first data corresponding to the profile of the user, second data as a response to the query;
selecting, according to a determination that a structure of the second data satisfies a heuristic corresponding to a second format, a second user interface configured to present output corresponding to the selected second format; and
causing the second user interface to present an output in the selected second format corresponding to at least a portion of the second data.

20. The non-transitory computer readable medium of claim 19, wherein the instructions, when executed by the one or more processors, cause the one or more processors to perform additional operations comprising:
selecting, according to a determination that a structure of the second data satisfies a third format distinct from the first format, the second user interface corresponding to the second format that satisfies the structure of the second data.
